(19) United States
(12) Patent Application Publication
(10) Pub. No.: US 2014/0292020 A1
(43) Pub. Date: Oct. 2, 2014

(54) Retractable Canopy Apparatus For a Golf Cart

(71) Applicant: Joseph Gallo, Villa Rica, GA (US)

(72) Inventor: Joseph Gallo, Villa Rica, GA (US)

(21) Appl. No.: 14/231,998

(22) Filed: Apr. 1, 2014

Related U.S. Application Data
(60) Provisional application No. 61/807,409, filed on Apr. 2, 2013.

(51) Int. Cl. B60J 7/12

(52) U.S. Cl. CPC B60J 7/1278
USPC 296/116

(57) ABSTRACT

A retractable canopy apparatus for use with a golf cart having forward and rearward passenger sections, a front canopy member, and a support rail on the rearward section includes an adjustment bracket coupled to a support rail. A support arm includes a first end pivotally coupled to the support bracket and an opposed second end. The support arm is movable relative to the adjustment bracket between stowed and deployed configurations. An auxiliary canopy assembly includes a front end coupled to an upper end of the golf cart framework and a rear end coupled to the second end of the support arm. A flexible canopy top member extends between the auxiliary canopy assembly front and rear ends. The top member is movable between an extended configuration when the adjustment member is at the deployed configuration and a collapsed configuration when the adjustment member is at the stowed configuration.

### REFERENCE TO RELATED APPLICATIONS

This application claims the priority of provisional patent application 61/807,409 filed Apr. 2, 2013 and titled Retractable Canopy Apparatus for a Golf Cart. The provisional patent application is hereby incorporated by reference in its entirety.

### BACKGROUND OF THE INVENTION

This invention relates generally to golf cart canopies and, more particularly, to a retractable auxiliary canopy for a golf cart of a type having a forward passenger section and a rearward passenger seating section.

Golf carts have long been used by golfers to travel around a golf course and, more recently, to travel around one's own property, along country roads, or the like. Many golf carts have a bench seat in a forward passenger area. The golf cart may also have a canopy or roof over this forward passenger area configured to protect the driver and a passenger from weather elements such as wind, rain, and sun.

Some golf carts, however, have a rearward section that may be used for auxiliary seating or for carrying cargo. Unfortunately, this rearward section is typically not protected by the main canopy or fixed roof. Various devices have been proposed in the art for providing an auxiliary covering configured to shield cargo such as a golf bag. Although assumably effective for their intended purposes, the existing devices do not provide an easily adjustable and deployable auxiliary canopy having a configuration substantially similar to the passenger seating canopy.

Therefore, it would be desirable to have a retractable canopy apparatus for use with a golf cart having a forward passenger seating area and an auxiliary/rearward seating area. Further, it would be desirable to have a retractable canopy apparatus that may be coupled to the support rails of the golf cart and which may be retracted or extended by passengers in the auxiliary seating area.

### SUMMARY OF THE INVENTION

A retractable canopy apparatus for use with a golf cart having a forward passenger section, a rearward section extending rearwardly of the forward passenger section, a front canopy member shielding the forward section, and a pair of support rails situated on the rearward section includes at least one adjustment bracket coupled to a support rail. The canopy apparatus includes at least one elongate support arm having a first end coupled to the at least one support bracket and a second end opposed to the first end. The support arm is movable relative to the adjustment bracket between a stowed configuration and a deployed configuration.

An auxiliary canopy assembly includes a front end coupled to an upper end of the golf cart framework and a rear end coupled to the second end of the support arm. The canopy assembly includes an auxiliary canopy top member extending between the front and rear ends of the auxiliary canopy assembly, the auxiliary canopy top member having a flexible construction. The auxiliary canopy top member is movable between an extended configuration when the adjustment member is at the deployed configuration and a collapsed configuration when the adjustment member is at the stowed configuration.

Therefore, a general object of this invention is to provide a retractable canopy for selectively shielding a golf cart from weather elements such as wind, rain, and sun.

Another object of this invention is to provide a retractable canopy, as aforesaid, that is selectively movable between a stowed configuration and a deployed configuration.

Still another object of this invention is to provide a retractable canopy, as aforesaid, having an auxiliary canopy top member that is made of a flexible material that may be moved between extended and retracted configurations.

Yet another object of this invention is to provide a retractable canopy, as aforesaid, that is easy to adjust.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a retractable canopy apparatus in user with a golf cart according to a preferred embodiment of the present invention illustrated in a deployed configuration with the canopy side member removed for clarity;

FIG. 2 is a perspective view of the retractable canopy apparatus as in FIG. 1 illustrated in a stowed configuration;

FIG. 3 is another perspective view of the retractable canopy apparatus as in FIG. 1;

FIG. 4 is an isolated view of an adjustment bracket taken from a portion of FIG. 1;

FIG. 5 is an isolated view of an adjustment bracket taken from a portion of FIG. 2; and

FIG. 6 is an isolated view of support arm taken from a portion of FIG. 1.

### DESCRIPTION OF THE PREFERRED EMBODIMENT

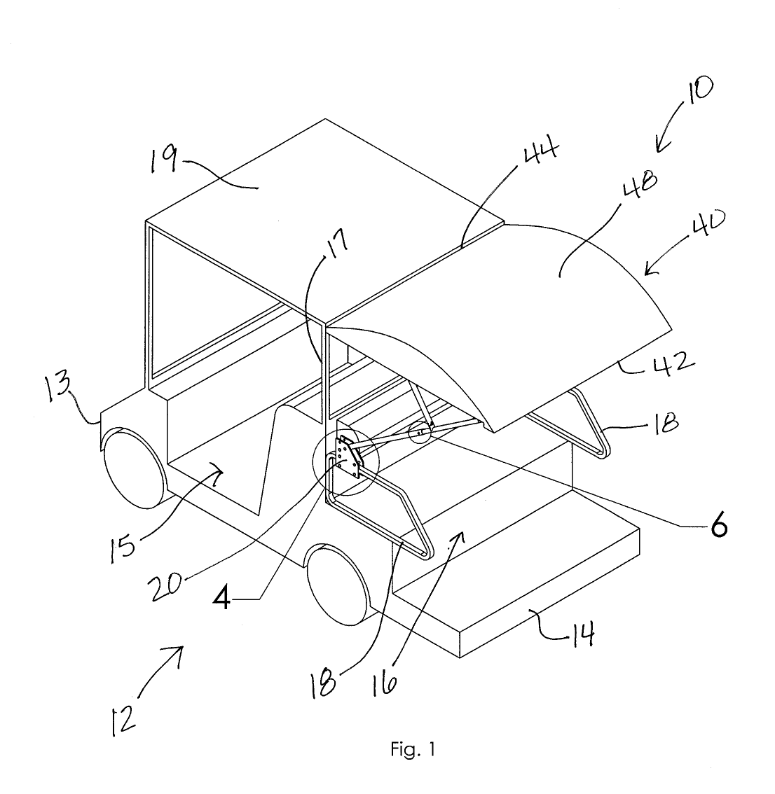

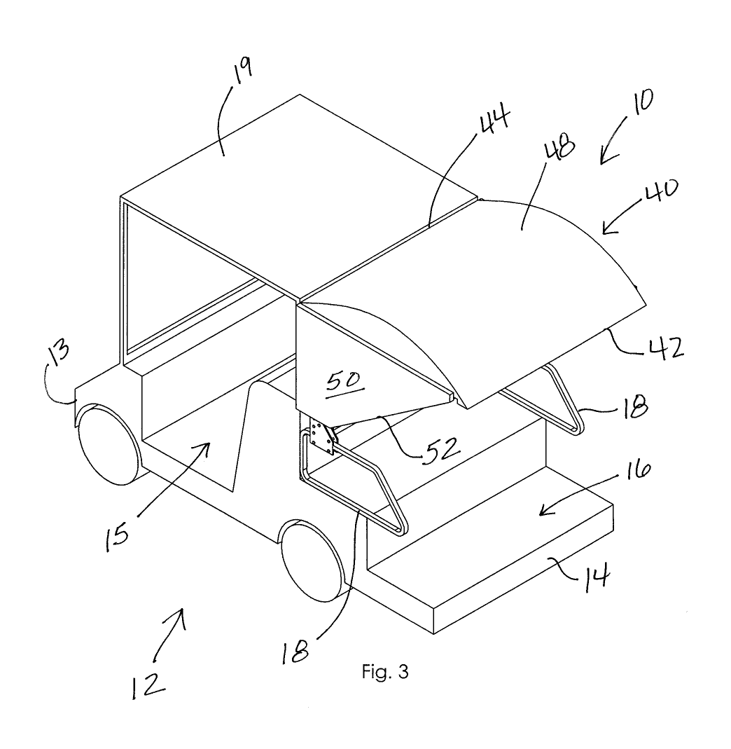

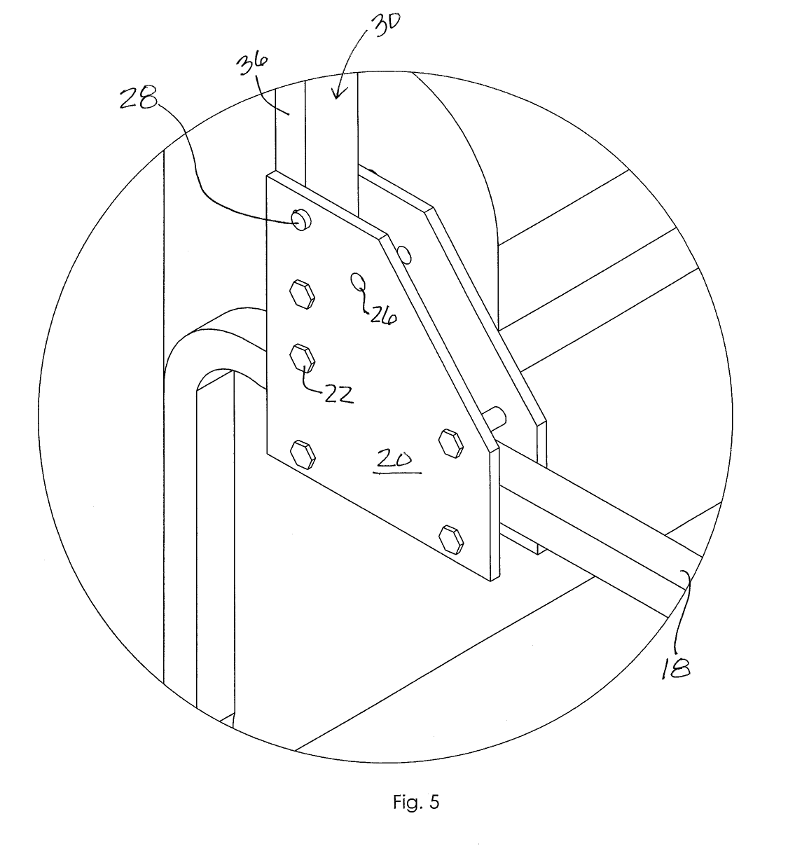

A retractable canopy apparatus according to a preferred embodiment of the present invention will be described in detail with reference to FIGS. 1 to 6 of the accompanying drawings. The retractable canopy apparatus 10 includes an adjustment bracket 20, a support arm 30, and a canopy assembly 40.

The retractable canopy apparatus 10 is best understood with a preliminary description of the type of golf cart for which it is designed. Specifically, the retractable canopy apparatus 10 is for use with a golf cart 12 having a frontward passenger section 15 adjacent a front end 13 of the golf cart 12 and a rearward section 16 adjacent a back end 14 of the golf cart 12, the rearward section 16 being rearwardly adjacent the frontward passenger section 15. In other words, the golf cart 12 for use with the present invention includes a traditional front seat area for a driver and passenger and also a rear seat area for additional passengers. The exemplary golf cart 12 also includes an upwardly extending framework 17 and a front canopy member 19 supported atop the framework 17. In addition, the exemplary golf cart 12 includes a pair of spaced apart hand rails 18 situated in the rearward section 16 as will be described in greater detail later.

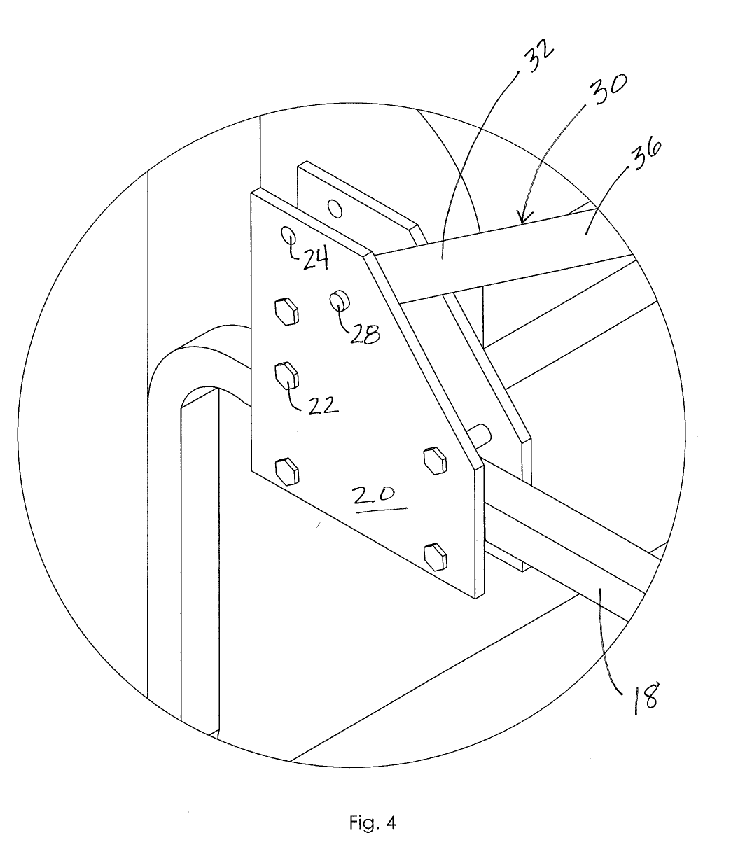

At least one adjustment bracket 20 is coupled to at least one support rail 18 of the golf cart 12 (FIGS. 1 and 4). It is understood that a pair of adjustments brackets 20 may be coupled to opposed side rails 18. As best shown in FIG. 4, each adjustment bracket 20 may define a plurality of apertures and include bolts 22 configured such that the adjustment bracket 20 may be quickly yet securely coupled to a support rail 18 of the golf cart 12. Of course, fasteners other than bolts 22 may be used to couple an adjustment bracket 20 to a support rail 18, such as clips, clasps, screws, rivets, or the like. Further, each adjustment bracket 20 defines at least a first hole 24 and a second hole 26 that will enable the canopy assembly 40 to be selectively positioned in stowed and deployed configurations as will be described in further detail below. An adjustment bracket pin 28 may be inserted into a respective adjustment hole to fix a support arm 30 at a stowed or deployed configuration, as will also be described below.

The elongate support arm 30 includes a first end 32 selectively coupled to a respective adjustment bracket 20. More particularly, the support arm first end 32 may be pivotally coupled to a respective adjustment bracket 20 and then releasably locked at either the first hole 24 or the second hole 26 when respective holes are aligned with complementary holes (not shown) defined by the support arm 30 (not shown) and the pin 28 is inserted therethrough. A support arm 30 also includes a second end 34 opposite the first end 32.

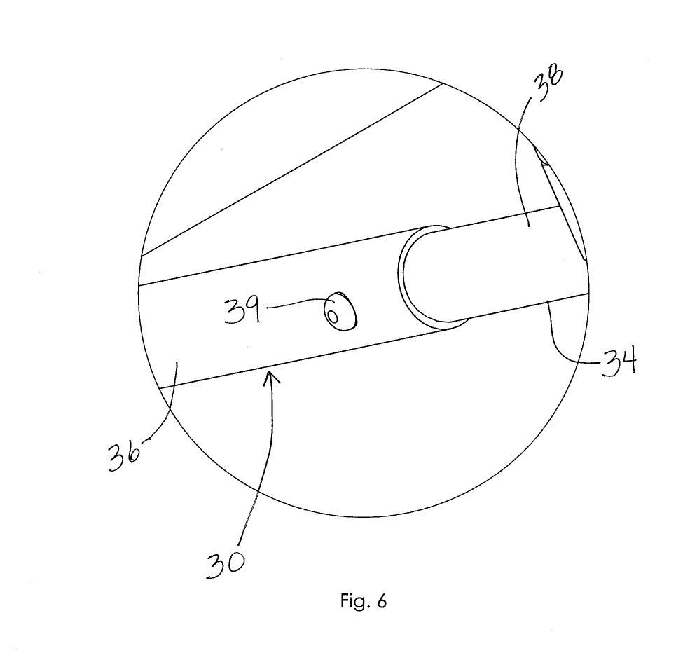

The support arm 30 has an elongate configuration and preferably is length adjustable. As shown in FIG. 6, a support arm 30 may include a lower section 36 having a hollow construction configured to selectively receive an upper section 38 therein. The support arm 30 is slidably movable between an extended configuration in which the upper section 38 is substantially displaced or extended from the lower section 36 and a retracted configuration in which the upper section 38 is substantially received inside the lower section 36. The support arm 30 may be held in an extended configuration with a pin 39 or other fastener or moved to a retracted configuration when the pin 39 is selectively removed. It is understood that the canopy apparatus 10 may include a pair of support arms 30 coupled to respective support brackets 20 as described above.

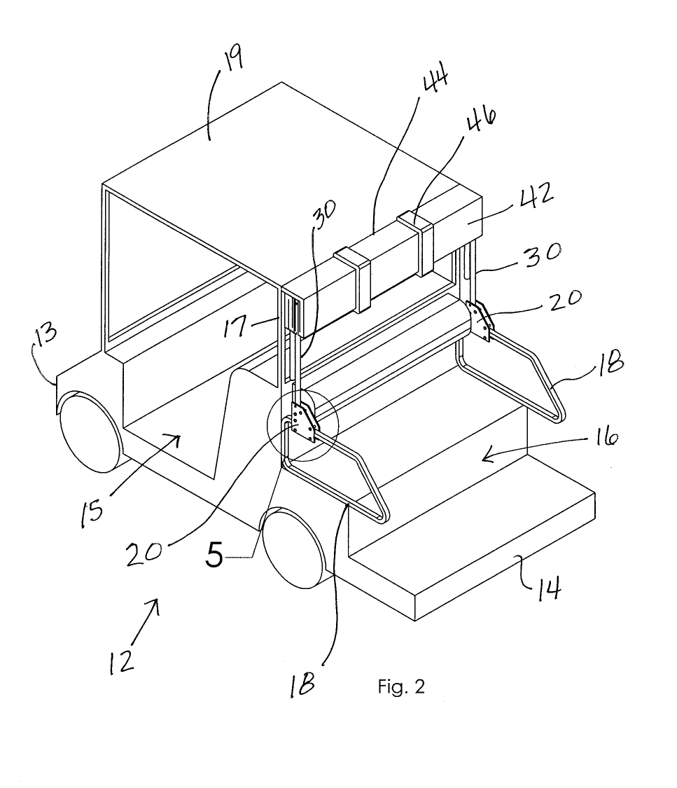

Each support arm 30 is selectively movable between a stowed configuration (FIG. 2) and a deployed configuration (FIG. 1). When the support arm 30 is releasably locked by inserting the pin 28 through the second hole 26 of the adjustment bracket 20 and into the support arm 30, the support arm 30 is angled in a rearward direction corresponding to an “open” or “deployed” configuration (FIG. 1). The pin 28, however, may be removed and the support arm 30 may be moved to a generally vertical configuration corresponding to a “closed” or “stowed” configuration. The pin 28 may then be inserted into first hole 24 so as to releasably lock the support arm in the stowed configuration (FIG. 2). It is understood that the support arm 30 may be moved to the retracted configuration at the stowed configuration so as not to extend above the canopy assembly.

The retractable canopy apparatus 10 includes an auxiliary canopy assembly 40. The auxiliary canopy assembly 40 may include a front end 42 coupled to an upper end of the golf cart framework 17 and a back end 44 coupled to the second end 34 of a respective support arm 30. The auxiliary canopy assembly 40 may also include an auxiliary canopy top member 48 that extends between the front 42 and back 44 ends of the auxiliary canopy assembly 40. The auxiliary canopy top member 48 is constructed of a flexible and resilient material so it may be moved between a generally extended or stretched configuration when the support arm 30 is at the deployed configuration (FIG. 1) and a retracted configuration when the support arm 30 is at the closed/stowed configuration (FIG. 2).

The auxiliary canopy assembly 40 may also include at least one securing fastener 46 such as a strap (FIG. 2). The securing fastener 46 may be configured to selectively hold the auxiliary canopy top member 48 at the stowed configuration.

The auxiliary canopy assembly 40 may also include an auxiliary canopy side member 50 having an upper end coupled to a side edge of the auxiliary canopy top member and a lower end coupled to a respective adjustment bracket 20. It is understood that there may be another auxiliary canopy side member depending from the other side of the auxiliary canopy top member 48 so that both sides of the rearward section 16 of the golf cart 12 may be shielded from weather elements such as rain or sun. A respective auxiliary canopy side member 50 may include a back edge 52 that is angled between the lower and upper ends thereof. The side member 50 is constructed of a flexible and resilient material that extends when the canopy assembly 40 is opened/deployed and becomes folded when the canopy member is retracted/stowed.

In use, the support arm 30 may be locked at the stowed configuration as described above whenever shielding the rearward section 16 of the golf cart is not desired. Then, when shielding is desired, the pin 28 may be removed from the adjustment bracket 20 (first hole 24) so as to release the support arm 30 to move from the generally vertical configuration to the rearwardly angled configuration and the pin 28 re-inserted into the adjustment bracket 20 (second hole 26). At the deployed configuration, the auxiliary canopy top member 48 and auxiliary canopy side member 50 are extended so as to shield the rearward section 16 of the golf cart 12 from weather elements such as wind, rain, and sun.

It is understood that while certain forms of this invention have been illustrated and described, it is not limited thereto except insofar as such limitations are included in the following claims and allowable functional equivalents thereof.

1. A retractable canopy apparatus for use with a golf cart having a forward section adjacent a front of the golf cart and a rearward section adjacent a back of the golf cart and extending rearwardly from the forward section, the golf cart including an upwardly extending framework, a front canopy member situated atop the framework, and a pair of support rails extending rearwardly adjacent the rearward section, said retractable canopy apparatus, comprising:
an adjustment bracket coupled to a respective support rail of the golf cart;
a support arm having a first end releasably coupled to said support bracket and having a second end opposed to said first end;
wherein said support arm is movable relative to said adjustment bracket between a stowed configuration at which said support arm extends generally vertically from said adjustment bracket and a deployed configuration in which said support arm extends at a rearward angle relative to said adjustment bracket;
an auxiliary canopy assembly comprising:
a front end coupled to an upper end of the golf cart framework and a back end coupled to said second end of said support arm; and
an auxiliary canopy top member extending between said front and rear ends of said auxiliary canopy assembly, said auxiliary canopy top member having a flexible construction;
wherein said auxiliary canopy top member is movable between an extended configuration when said support arm is at said deployed configuration and a collapsed configuration when said support arm is at said stowed configuration.

2. The retractable canopy apparatus as in claim 1, wherein said auxiliary canopy assembly includes an auxiliary canopy side member having an upper end coupled to a side edge of said auxiliary canopy top member and a lower end removably coupled to said adjustment bracket.

3. The retractable canopy apparatus as in claim 2, wherein said auxiliary canopy side member includes a back edge having an angled configuration that extends between said adjustment bracket and said auxiliary canopy top member.

4. The retractable canopy apparatus as in claim 1, wherein said support arm is length adjustable and movable between a retracted configuration and an extended configuration.

5. The retractable canopy apparatus as in claim 4, wherein:
said support arm includes a lower section and an upper section, said lower section defining a hollow interior space configured to slidably receive said upper section therein; and
said support arm being movable between said extended configuration in which said upper section is substantially displaced from said lower section and said retracted configuration in which said upper section is substantially inside said lower section.

6. The retractable canopy apparatus as in claim 1, wherein:
said adjustment bracket is a pair of adjustment brackets coupled to the pair of side rails of the golf cart, respectively;
elongate support arm is a pair of support arms pivotally coupled to said pair of adjustment brackets, respectively.

7. The retractable canopy apparatus as in claim 6, wherein each support arm includes a first end releasably coupled to a respective support bracket and a second end opposed to said first end.

8. The retractable canopy apparatus as in claim 6, wherein said pair of support arms are movable relative to respective adjustment brackets between a stowed configuration at which said pair of support arms extend generally vertically from said respective adjustment brackets and a deployed configuration at which said pair of support arms extend at a rearward angle relative to said respective adjustment brackets.

9. The retractable canopy apparatus as in claim 1, wherein said support arm is selectively locked at said stowed configuration such that said support arm extends generally vertically from said adjustment bracket or selectively locked at said extended configuration such that said support arm extends at a rearwardly angled direction from said adjustment bracket.

10. A retractable canopy apparatus for use with a golf cart having a forward section adjacent a front of the golf cart and a rearward section adjacent a back of the golf cart and extending rearwardly from the forward section, the golf cart including an upwardly extending framework, a front canopy member situated atop the framework, and a pair of support rails extending rearwardly adjacent the rearward section, said retractable canopy apparatus, comprising:
a pair of brackets coupled to respective support rails of the golf cart;
a pair of support arms, each respective support arm having a first end releasably coupled to a respective support bracket and having a second end opposed to said first end;
wherein said pair of support arms are movable relative to respective adjustment brackets between a stowed configuration at which said pair of support arms extend generally vertically from said respective adjustment brackets and a deployed configuration at which said pair of support arms extend at a rearward angle relative to said respective adjustment brackets;
an auxiliary canopy assembly comprising:
a front end coupled to an upper end of the golf cart framework and a back end coupled to respective second ends of respective support arms; and
an auxiliary canopy top member extending between said front and rear ends of said auxiliary canopy assembly, said auxiliary canopy top member having a flexible construction;
wherein said auxiliary canopy top member is movable between an extended configuration when said pair of support arm are at said deployed configuration and a collapsed configuration when said pair of support arms are at said stowed configuration.

11. The retractable canopy apparatus as in claim 10, wherein said auxiliary canopy assembly includes an auxiliary canopy side member having an upper end coupled to a side edge of said auxiliary canopy top member and a lower end removably coupled to a respective adjustment bracket.

12. The retractable canopy apparatus as in claim 11, wherein said auxiliary canopy side member includes a back edge having an angled configuration that extends between said respective adjustment bracket and said auxiliary canopy top member.

13. The retractable canopy apparatus as in claim 10, wherein each support arm is length adjustable and movable between a retracted configuration and an extended configuration.

14. The retractable canopy apparatus as in claim 13, wherein:
said each support arm includes a lower section and an upper section, said lower section defining a hollow interior space configured to slidably receive said upper section therein; and
said each support arm being movable between said extended configuration in which said upper section is substantially displaced from said lower section and said retracted configuration in which said upper section is substantially inside said lower section.
